(19) United States
(12) Patent Application Publication
(10) Pub. No.: US 2006/0134480 A1
(43) Pub. Date: Jun. 22, 2006

(54) A SENSOR ASSEMBLY FOR MEASURING HUMIDITY, PRESSURE AND TEMPERATURE

(75) Inventors: Jon Beasley, Dearborn, MI (US); Bradley Spare, Oceanside, CA (US); Marco Mularoni, Phoenix, AZ (US)

Correspondence Address: BROOKS KUSHMAN P.C./FGTL, 1000 TOWN CENTER, 22ND FLOOR, SOUTHFIELD, MI, 48075-1238, US

(73) Assignees: FORD MOTOR COMPANY, Dearborn, MI (US); HUMIREL, INC, Phoenix, AZ (US)

(21) Appl. No.: 11/163,166

(22) Filed: Oct. 7, 2005

Related U.S. Application Data
(60) Provisional application No. 60/616,827, filed on Oct. 7, 2004.

(51) Int. Cl. H01M 8/04

(52) U.S. Cl. 429/22; 429/24; 429/25; 429/26

(57) ABSTRACT

A sensor for measuring and controlling pressure, temperature and relative humidity of a gas process stream for a powerplant is disclosed. Sensor elements are integrated to form a compact module at a single location in the stream.

### CROSS-REFERENCE TO RELATED APPLICATIONS

This application claims the benefit of U.S. provisional application Ser. No. 60/616,827 filed Oct. 7, 2004.

### BACKGROUND OF THE INVENTION

1. Field of the Invention

The invention relates to powerplants, including hydrogen fuel cells, for use in automotive vehicle powertrains, and to a sensor used in the control of temperature, pressure and humidity in a gas process stream for the powerplant.

2. Background Discussion

Hydrogen fuel cells are characterized by an electrochemical reaction that converts energy of a fuel, such as hydrogen, directly to electrical energy. They function in a manner analogous to a battery as fuel is supplied to an anode or positive electrode and an oxidant is supplied to a cathode or negative electrode. Typically, the oxidant is air obtained from the ambient environment and the fuel is hydrogen. The fuel may be hydrogen gas from a high pressure hydrogen gas storage tank, a hydrocarbon fuel or natural gas.

Fuel cells chemically combine the hydrogen molecules of the fuel and oxygen molecules of the oxidant in a process without burning. In this respect, fuel cells differ from power sources in which energy is extracted by fuel combustion where combustion heat is converted to mechanical energy. In the case of an internal combustion engine, mechanical energy is developed as combustion occurs in the engine combustion chambers. Alternatively, combustion heat can be converted to mechanical energy by a gas turbine, which can power an electric machine, such as a dynamo. Unlike conventional power units, such as an internal combustion engine or a gas turbine, fuel cells are capable of chemically combining hydrogen and oxygen molecules with relatively high efficiency process and with little or no pollution due to exhaust gas emissions.

Fuel cells require two independent gas process stream circuits, one comprising a reactant fuel stream leading to the anode and the other comprising an oxidant stream leading to the cathode. In order to maintain proper operating conditions for the fuel cell, the temperature, the pressure and the humidity levels of the anode and cathode circuits must be precisely controlled to provide optimum operating efficiency and to avoid drying of an electrolyte in the fuel cell or otherwise damaging the fuel cell. The anode and the cathode are separated in the fuel cell by the electrolyte.

In the case of a fuel cell capable of being used in the powertrain of an automotive vehicle, it is desirable in some instances to use hydrogen gas as the fuel. The system must be small and of reduced weight because of packaging constraints typically required for use in an automotive vehicle powertrain. Furthermore, automotive applications subject the fuel cell to a wide range of operating conditions, such as variations in temperature and humidity. They furthermore must be sufficiently robust to withstand the vibrations and stresses, both mechanical and thermal, induced by typical vehicle applications.

Optimum efficiency of the fuel cell requires the fuel reactant and the oxidant to be uniformly in contact with the electrodes. Further, the pressure of the circulated gases at every point on electrodes should be controlled. Low pressures on one side of the fuel cell may create electrode flooding, and unduly high pressures may cause mechanical damage. Reaction products may be formed at either or both electrodes. These products must be removed to allow efficient contact of the circulating fluids with the electrodes.

The reaction of the fuel and the oxidant within the fuel cell liberates heat and generates higher than ambient temperatures. These high temperatures may accelerate degradation of the ion exchange materials that comprise the electrolyte. Consequently, coolant fluid must be circulated through a heat exchanger for the fuel cell to dissipate the heat of reaction. This must be accomplished with optimum flow rates to prevent waste of fuel or oxidant. Further, high pressures must be avoided to avoid failure of the fuel cell elements.

In addition to precise control of temperature and pressure, the fuel stream and the oxidant stream must be humidified. Fuel cells require humidification of the hydrogen fuel stream input to the fuel cell's anode to prevent drying of the electrolyte within the fuel cell. The oxidant stream must be humidified to effect efficient ion exchange.

In the control of the reactant stream and the oxidant stream in a fuel cell system, the typical process variables that must be controlled include temperature, pressure and relative humidity. In a conventional fuel cell system, separate sensors are required for measuring these variables. This increases the cost of the system and creates packaging problems in an automotive powertrain environment because of the need for providing sensor leads, separate mounting brackets and space for the sensors. Further, the required high relative humidity of the cathode and anode process streams in a typical fuel cell system makes it difficult to make accurate humidity measurements if water condenses on the humidity sensor. When water condenses on the humidity sensor, the humidity sensor generates erroneous readings.

Known methods for making humidity measurements are complicated, bulky and inherently involve excessive time lags. Attempts have been made to overcome this problem of water vapor condensation on the humidity sensor by diverting a small stream from the reactant process stream or from the oxidant process stream and then heating the diverted stream to a temperature above the expected dew point. A humidity measurement then is made. This process complicates the system. The need for separate readings of these variables slows transfer of sensor data to the fuel cell controller. Further, the need for providing separate pressure, temperature and humidity measurements requires additional wiring and appropriate fittings thereby increasing cost and adding a weight penalty to the system.

If the temperature, the pressure and the relative humidity of a gas process stream in a fuel cell are measured separately at different locations in the process stream, precise measurements of relative humidity at the humidity sensor becomes difficult since each of these variables measured at one location in the process stream will not necessarily be identical to the value of that variable measured at a different location in the process stream.

### SUMMARY OF THE INVENTION

Although a fuel cell system incorporating the sensor of the invention has been disclosed, the invention may be used also in powertrain systems that include an internal combustion engine or gas turbine engine where mass air flow must be measured and used as one of the engine control variables. Presently, mass air flow sensors in engine control systems may develop erroneous readings if the effect of water vapor in the air intake flow or in the fuel/air mixture flow is not taken into account.

The invention comprises a sensor assembly that is mounted at a strategic location in a gas process stream that is safe from splashes and liquid water droplet impingement due to water vapor condensation. This is accomplished by mounting a temperature sensor element and an electric heater, along with a humidity sensor element, in a compact, integrated module.

A pressure sensor element having a gas inlet adjacent the module measures gas pressure at the location of the module. A second main temperature may be located adjacent the module to measure the temperature around the module.

The output of the sensors communicates with a digital serial bus. This reduces the number of sensor lead wires compared to conventional powertrain applications that require measurements of temperature, pressure and relative humidity. Typical data presented on the bus are temperature, pressure, relative humidity and dew point.

The sensor assembly includes a housing that contains a microprocessor controller that is electronically coupled to the sensor elements through a digital serial bus. The module is surrounded by an apertured barrel. The module is disposed in the barrel and is thermally isolated from it by an inner porous sleeve. The sensor elements and the heater in the module are secured within the inner sleeve.

### BRIEF DESCRIPTION OF THE DRAWINGS

FIG. 1 shows a fuel cell system that incorporates the temperature/pressure/humidity sensor of the invention; and

FIG. 2 is a cross-sectional view of the sensor assembly of the invention.

### PARTICULAR DESCRIPTION OF AN EMBODIMENT OF THE INVENTION

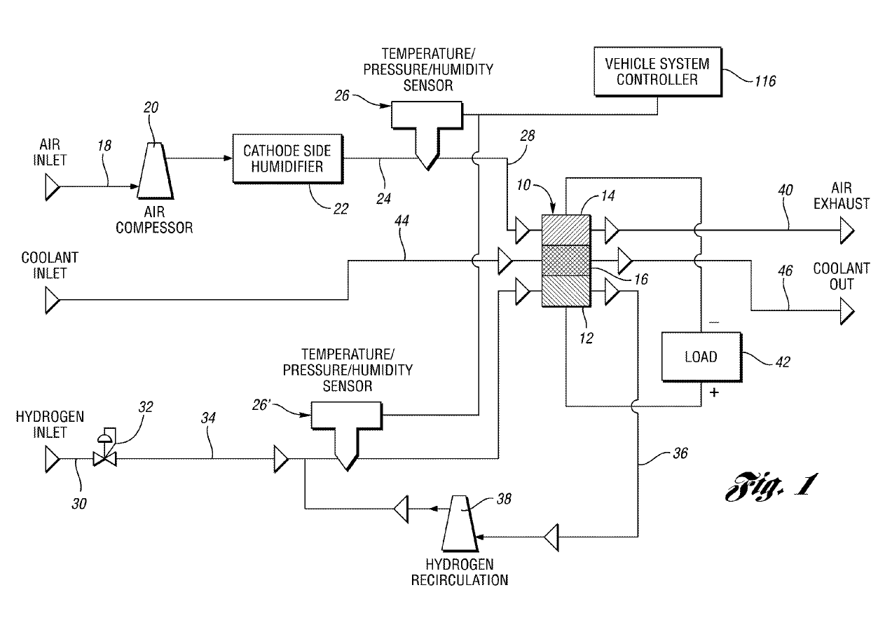

FIG. 1 shows a system for a hydrogen fuel cell that embodies the invention. The fuel cell is schematically illustrated at 10. It includes an anode 12, a cathode 14 and a heat exchanger or cooler 16. Air is used in the system of FIG. 1 as a source of oxygen. The air inlet at 18 is compressed by an air compressor 20 connected to a humidifier 22, which raises the relative humidity at the input side 24 of temperature/pressure/humidity sensor 26. The efficiency of the ion exchange at the fuel cell 10 is enhanced if the humidity at the cathode inlet side 28 is at a pre-calibrated level.

The fuel, in the case of the fuel cell system of FIG. 1, is hydrogen. The inlet for the hydrogen fuel, shown at 30, may be at a pressure of 5,000 to 10,000 pounds per square inch. The pressure is regulated to a lower level by pressure regulator 32, which establishes a controlled pressure in hydrogen fuel inlet passage 34.

The anode 12 receives hydrogen gas flow. A humidity sensor 26′ is located in the hydrogen fuel inlet passage 34 to ensure that the pressure, temperature and humidity for the process stream for the anode are at calibrated levels. The humidity must be controlled to prevent the electrolyte of the fuel cell from drying out.

Hydrogen is recirculated through passage 36 from the anode 12 back to the inlet passage 34. The recirculated hydrogen flow path includes a recirculation pump 38. The air distributed to the cathode 14 from inlet passage 28 provides oxygen for the ion exchange, which creates water vapor. The excess air then is exhausted through an air exhaust passage 40.

A load, such as an electric motor 42, is powered by the electrical potential developed by the fuel cell.

Coolant is distributed to the cooler 16 through coolant inlet passage 44, which collects heat generated by the ion exchange in the fuel cell 10. The heat then is discharged through the coolant outlet flow passage 46. In a typical automotive powertrain environment, the coolant outlet passage 46 would return coolant to the engine radiator. It then is recirculated to the coolant inlet passage 44.

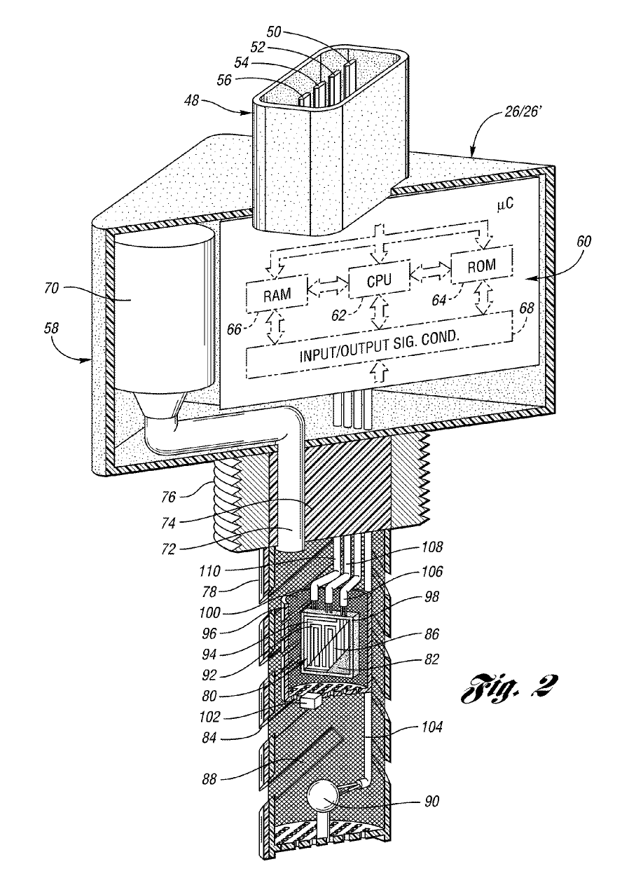

The sensor of the invention is shown in the schematic cross-sectional view of FIG. 2. It includes a connector 48. The connector comprises a power pin 50, a ground pin 52 and signal pins 54 and 56, which form a part of a digital serial bus communication protocol network that includes a vehicle system controller, shown at 116 in FIG. 1.

The main body of the sensor of FIG. 2 is shown at 58. The main body houses a microprocessor controller 60, which includes a central processor unit 62, ROM memory registers 64, RAM memory registers 66 and input/output signal conditioning elements 68. Body 58 also encloses a pressure sensor 70, which is connected to the process stream by an inlet passage, or tube, 72. The main housing is isolated from the process stream by seal 74. The body is threaded in the structure for the process stream by a threaded portion 76.

A main barrel 78 for the sensor houses the humidity sensor and the temperature sensor, which respectively are designated by reference numerals 80 and 82. The barrel 78 is slotted, as shown at 84, to allow gas flow to the sensor elements while deflecting liquid water. A heater 86 is disposed directly adjacent the humidity sensor 80 and the temperature sensor 82. The heater 86 includes electric resistance wiring in a thermal insulating and heat absorption material.

An inner liner 88, which may be a mesh liner, allows passage of gases therethrough in the process stream, it is disposed within the barrel 78. This liner helps prevent liquid water from reaching the sensor elements 80, 82 and 86.

A main gas flow temperature sensor 90 is located in the barrel at a location below the sensors 80, 82 and 86. The main temperature sensor 90 can be a standard sensor, such as a thermocouple, a thermistor or an RTD sensor depending on the precision required.

The humidity sensor 80 is a capacitive humidity sensor that includes conductive material 92 separated by capacitive material 94. The capacitive material has a variable capacitance depending upon the moisture content of the surrounding gas stream. A variation in the capacitance will be an indicator of the water vapor content of the process stream.

The humidity sensor is mounted inside an inner sleeve 96. The heater element 86 keeps the enclosure within the inner sleeve above the condensation point for the process stream. This prevents condensation on the humidity sensor element 80. If condensation were present, that would create an error, as explained previously. The temperature sensor 82 is used to maintain the temperature of the inner sleeve 96, as well as to establish the dew point of the process stream.

A bracket 98 is used to mount the humidity sensor, the heater and the temperature sensor to form a compact isothermal block or module.

The inner sleeve 96 has a mesh liner 100, which further helps prevent liquid water from reaching the humidity sensor. One or more mounting brackets 102 support the inner sleeve to thermally isolate the sleeve from the main barrel 78 and the liner 88.

The leads from the temperature sensor 90 are shown at 104, the leads for the humidity sensor 80 are shown at 106, the leads for the heater element are shown at 108 and the leads for the humidity sensor are shown at 110. These leads extend to the input/output signal conditioning portion 68 of the microprocessor 60. The inlet for the pressure sensor 70 is located directly adjacent the humidity sensor and the temperature sensor so that each reading of these three variables takes place at a single location in the process stream.

Although a digital serial bus communication protocol network can be used, as previously explained, a wireless sensor network also can be used, if that is desired, without departing from the scope of the invention. The network is multiplexed in the disclosed embodiment.

The pressure, temperature and humidity sensors distribute data to microprocessor 60, which will calculate psychrometric values according to well known thermodynamic relationships. The heater will be activated, as determined by microprocessor 60, to control the temperature, thereby avoiding condensation on the humidity sensor.

The microprocessor 60 will condition the signals received at 68. It will attenuate or eliminate extraneous electrical noise from the signal. Real-time sensor data values determined by the central processor unit are distributed to the vehicle system controller, shown in FIG. 1 at 116, through the control area network.

Although an embodiment of the invention has been disclosed, it will be apparent to persons skilled in the art that modifications may be made without departing from the scope of the invention. All such modifications and equivalents thereof are intended to be covered by the following claims.

What is claimed is:

1. A sensor assembly for measuring pressure temperature and relative humidity in a gas process stream for a powerplant that is fueled by a hydrogen reactant in the presence of an oxidant, the sensor assembly comprising:
a first temperature sensor disposed at a strategic location in the gas process stream;
a humidity sensor disposed adjacent the temperature sensor;
an electric heater disposed adjacent the humidity sensor;
the temperature sensor, the humidity sensor, and the electric heater being assembled together to define an integrated compact module;
a second main temperature sensor in the gas process stream adjacent the module; and
a pressure sensor including a gas inlet adjacent the module in the gas process stream.

2. A sensor assembly for measuring pressure, temperature and relative humidity in a gas process stream for a powerplant that is fueled by hydrogen in a gaseous state in the presence of air, the air being an oxygen source, the sensor assembly comprising:
a first temperature sensor disposed at a strategic location in the gas process stream;
a humidity sensor disposed adjacent the temperature sensor;
an electric heater disposed adjacent the temperature sensor;
an electric heater disposed adjacent the humidity sensor;
the temperature sensor, the humidity sensor and the electric heater being assembled together to define an integrated, compact module;
a second main temperature sensor in the gas process stream adjacent the module; and
a pressure sensor including a gas inlet adjacent the module in the gas process stream.

3. A sensor assembly for measuring pressure temperature and relative humidity in a gas process stream for a powerplant that is fueled by a hydrogen reactant in the presence of an oxidant, the sensor assembly comprising:
a temperature sensor disposed at a strategic location in the gas process stream;
a humidity sensor disposed adjacent the temperature sensor;
an electric heater disposed adjacent the humidity sensor;
the temperature sensor, the humidity sensor and the electric heater being assembled together to define an integer compact module; and
a pressure sensor including a gas inlet adjacent the module in the gas process stream.

4. A sensor assembly for measuring pressure, the temperature and relative humidity in a gas process stream for a powerplant that is fueled by hydrogen in a gaseous state in the presence of air, the air being an oxygen source, the sensor assembly comprising:
a temperature sensor disposed at a strategic location in the gas process stream;
a humidity sensor disposed adjacent the temperature sensor;
an electric heater disposed adjacent the temperature sensor;
an electric heater disposed adjacent the humidity sensor;
the temperature sensor, the humidity sensor and the electric heater being assembled together to define an integrated, compact module;
a pressure sensor including a gas inlet adjacent the module in the gas process stream; and
a microprocessor controller in electronic communication with the sensors for controlling relative humidity whereby water vapor condensation on the humidity sensor is avoided.

5. A sensor assembly for measuring pressure temperature and relative humidity in a gas process stream for a fuel cell engine that is fueled by a hydrogen reactant in the presence of an oxidant, the sensor assembly comprising:
a first temperature sensor disposed at a strategic location in the gas process stream;
a humidity sensor disposed adjacent the temperature sensor;
an electric heater disposed adjacent the humidity sensor;
the temperature sensor, the humidity sensor and the electric heater being assembled together to define an integrated, compact module;
a second main temperature sensor in the gas process stream adjacent the module;
a pressure sensor including a gas inlet adjacent the module in the gas process stream; and
a microprocessor controller in electronic communication with the sensors for controlling relative humidity whereby water vapor condensation on the humidity sensor is avoided.

6. A sensor assembly for measuring pressure, temperature and relative humidity in a gas process stream for a fuel cell engine that is fueled by hydrogen in a gaseous state in the presence of air, the air being an oxygen source, the sensor assembly comprising:
a temperature sensor disposed at a strategic location in the gas process stream;
a humidity sensor disposed adjacent the temperature sensor;
an electric heater disposed adjacent the temperature sensor;
an electric heater disposed adjacent the humidity sensor;
the temperature sensor, the humidity sensor and the electric heater being assembled together to define an integrated, compact module;
a pressure sensor including a gas inlet adjacent the module in the gas process stream; and
a microprocessor controller in electronic communication with the sensors for controlling relative humidity whereby water vapor condensation on the humidity sensor is avoided.

7. The sensor assembly set forth in claim 2 comprising a housing having a first portion containing a microprocessor controller and a second barrel portion enclosing the humidity sensor, the temperature sensor and the electric heater, the barrel portion being apertured to accommodate gas flow; and
a porous sleeve within the barrel portion to shield the humidity sensor from water vapor condensation;
the temperature sensor, the humidity sensor and the heater in the module being thermally isolated by mounting elements from the barrel portion and the porous sleeve.

8. The sensor assembly set forth in claim 3 comprising a housing having a first portion containing a microprocessor controller and a second barrel portion enclosing the humidity sensor, the temperature sensor and the electric heater, the barrel portion being apertured to accommodate gas flow; and
a porous sleeve within the barrel portion to shield the humidity sensor from water vapor condensation;
the temperature sensor, the humidity sensor and the heater in the module being thermally isolated by mounting elements from the barrel portion and the porous sleeve.

9. The sensor assembly set forth in claim 4 comprising a housing having a first portion containing a microprocessor controller and a second barrel portion enclosing the humidity sensor, the temperature sensor and the electric heater, the barrel portion being apertured to accommodate gas flow; and
a porous sleeve within the barrel portion to shield the humidity sensor from water vapor condensation;
the temperature sensor, the humidity sensor and the heater in the module being thermally isolated by mounting elements from the barrel portion and the porous sleeve.

10. The sensor assembly set forth in claim 7 including a porous liner within the porous sleeve, the module being positioned within the liner whereby the humidity sensor is further protected from water vapor condensation.

11. The sensor assembly set forth in claim 8 including a porous liner within the porous sleeve, the module being positioned within the liner whereby the humidity sensor is further protected from water vapor condensation.

12. The sensor assembly set forth in claim 9 including a porous liner within the porous sleeve, the module being positioned within the liner whereby the humidity sensor is further protected from water vapor condensation.

13. The sensor assembly set forth in claim 1 wherein the powerplant is a hydrogen fuel cell with an anode, a cathode and an electrolyte material between the anode and the cathode, the fuel cell having a hydrogen gas process stream extending to the anode and an air process stream extending to the cathode;
the sensor assembly being exposed to the process stream whereby ion exchange between the anode and the cathode occur with enhanced efficiency as the relative humidity is controlled.

14. The sensor assembly set forth in claim 1 wherein the powerplant is a hydrogen fuel cell with an anode, a cathode and an electrolyte material between the anode and the cathode, the fuel cell having a hydrogen gas process stream extending to the anode and an air process stream extending to the cathode;
the sensor assembly being exposed to the hydrogen gas process stream whereby drying of the electrolyte is avoided as relative humidity in the hydrogen gas process stream is controlled.
